(19) United States
(12) Patent Application Publication
(10) Pub. No.: US 2015/0187344 A1
(43) Pub. Date: Jul. 2, 2015

(54) Percussion Box

(71) Applicant: Daniel Vea James, Salt Lake City, UT (US)

(72) Inventor: Daniel Vea James, Salt Lake City, UT (US)

(21) Appl. No.: 14/145,885

(22) Filed: Dec. 31, 2013

(51) Int. Cl. G10D 13/02; F21V 33/00

(52) U.S. Cl. CPC G10D 13/02; F21V 33/0056

(57) ABSTRACT

A percussion box musical instrument includes a single, unitary, continuous shell formed of a plastic material and having integral and continuous exterior walls which collectively enclose a hollow interior cavity. The various walls, having a support surface to play on, and to support and or attach peripheral percussion instruments. The walls have molded in features of various sizes and shapes that produce different unique percussion sounds, as well as a handle for carrying. The front wall faces an audience and has an area for signage. The bottom wall provides a place for an access panel or door so that instruments can be stored inside the box. The percussion box is configured so that it can be played on the lap, on a stand, standing up using a strap, or on the floor using the feet.

### CROSS-REFERENCE TO RELATED APPLICATIONS

| | |
|---|---|
| Current U.S. Class: | 84/411 |
| Current International Class: | G10D 13/02 |
| Field of Search: | 84/411 |

### REFERENCES CITED

### U.S. Patent Documents

| 8487170B2 | Jul. 16, 2013 | Klein |
|---|---|---|
| 2013180382 | Jul. 18, 2013 | Buchner |
| 7816596B2 | Oct. 19, 2010 | Bottger |
| 7692083B2 | Apr. 6, 2010 | Aspland |
| 5,385,075 | Jan. 31, 1995 | Carnes et al. |
| 8115088B2 | Feb. 14, 2012 | Herrera |
| 3,326,074 | Jun. 20, 1967 | Osty et al. |
| 4,577,541 | Mar. 25, 1986 | Edge |
| 4,593,596 | Jan. 10, 1986 | Gauger |
| 4,779,507 | Oct. 25, 1986 | Shimoda |

### Foreign Patent Documents

| | | |
|---|---|---|
| 2,433,277 | October 2013 | GB |

### BACKGROUND OF THE INVENTION

1. The Field of the Invention

The present invention relates generally to a percussion instrument. More particularly, the present invention relates to a light-weight, durable, percussion instrument formed of a single continuous shell that includes different wall sections that produce different sounds when struck, indentations and rises single and set in patterns that produce different sounds when struck, and at least one recess for holding or attaching additional instruments.

2. The Background Art

Percussion instruments are typically used by musicians in performing music for him or herself or to an audience. A musician may utilize the percussion box to produce percussive sounds and to hold other instruments for use when needed. In addition, the musician may utilize the instrument to advertise by attaching signage to the instrument. Instruments are used to add to the show or production as the audience watches the musician play the instrument.

Such percussion instruments may be used in various situations, such as practicing, composing, teaching, music performances of all kinds, etc. In addition, such drums may be used in various different settings or environments, such as homes, schools, churches music halls, classrooms, symphony halls, or outdoors etc.

Typically, percussion instruments are utilized in performance to add dynamics and rhythm to the music, with or without specific pitch or notes involved. They typically produce short very low to very high pitch tones as in a bass drum or a triangle, along with longer combination sounds by scraping such as with sand blocks or a cuica.

Unfortunately, similar types of percussion instruments only produce one type of sound and do not provide storage or a place to set other instruments on until needed. Some percussion instruments are large and or heavy and some require substantial time to set up. For example, a trap set which incorporates several percussion instruments ie a kick drum, snare, tom toms cymbals and hi hat, take substantial room to store and transport plus take a long time to set up and take down. It can often require a separate vehicle to transport a trap set. Larger drum sets are not portable while playing, requiring the drummer to sit behind the drum set somewhat restricted from view of the audience.

One disadvantage of such percussion instruments is their weight and size makes them difficult to transport. They take several trips from the transporting vehicle to the stage to set up. This with the substantial time to set up requires the musicians to arrive extra early to perform. The disadvantage of using several percussion instruments is the musician is either limited to a few sounds, limiting the performance or keeping track of a large number of different fragile, expensive instruments and having a place to put them when not in use. Either way there are no small percussion instruments that produce a deep bass sound, limiting the dynamics of the performance. Another disadvantage of such small percussion instruments is their lack of durability when transported. They are often made of wood which is easily scratched and can break if not used properly. The wood material of these instruments is easily damaged, scratched, and dented, giving the instrument an old, abused appearance, less suitable for making positive impressions. Another disadvantage with such percussion instruments is their method of construction, using multiple assembled parts makes them expensive to make and they become weakened by constant movement and being beat on.

There are a few types of percussion instruments that provide a deep bass sound but they are large, take care, and are limited to a certain type of sound. Such instruments have the same disadvantages in difficulty of transport, take a lot of room, and are susceptible of deterioration from use and abuse. Many require large heavy stands to hold them and are not portable. Some of these instruments are not ergonomic requiring the musician to bend over or overextend their arms when they play, resulting in fatigue and temporary or permanent injury when used for a long period of time and or over the years.

Recently cajons have become popular but they are limited to only a few different tones and require the musician to bend over and overextend the arms while playing. There are some cajons that incorporate ways to altering the sound but again they are limited. Cajons are typically made of wood which is susceptible to warping, cracking, and breaking down at the joints. Because of their shape, construction, and the way they are played, they do not offer a means to attach or set peripheral instruments on while playing.

With the advent of using microphones to amplify percussion instruments, it typically requires quite a number of microphones, microphone stands, microphone cords, audio snakes, and channels on a mixer to amplify percussion sounds when a musician wants to have several percussion sounds available. This can add up to a large investment in audio products and can take an hour to set up for each performance location. There are electronic instruments that can be a little smaller, less expensive and lighter but they lack the nuances of playing an acoustic instrument and always require and electronic sound reinforcement system.

### BRIEF SUMMARY OF THE INVENTION

A percussion box musical instrument includes a single, unitary, continuous shell formed of a plastic material and having integral and continuous exterior walls which collectively enclose a hollow interior cavity. The various walls, having a support surface to play on, and to support and or attach peripheral percussion instruments. The walls have molded in features of various sizes and shapes that produce different unique percussion sounds, as well as a handle for carrying. The front wall faces an audience and has an area for signage. The bottom wall provides a place for an access panel or door so that instruments can be stored inside the box. The percussion box is configured so that it can be played on the lap, on a stand, standing up using a strap, or on the floor using the feet.

### DETAILED DESCRIPTION OF THE INVENTION

It has been recognized; musicians would like to have an acoustic instrument that includes a deep bass sound along with several other percussion sounds in a single instrument. It would be advantageous to develop a light weight, durable, portable, small percussion instrument that is ergonomic, allowing the musician to play the instrument while maintaining proper posture, and not overextending the arms or requiring repetitive wrist movement. It would be valuable to have an instrument that was inexpensive, that would be simple, and quick to set up weather microphones are used or not. It would also be an advantage to not obstruct the percussionist and that the instrument can be played sitting down. It has been recognized that the performance can be more dynamic if the percussionist was allowed to stand and play the instrument using a stand or a strap to hold the instrument so he can move about while playing. It has been further recognized that it would be valuable to build in the ability to customize or add to the sounds the instrument produces to personalize the instrument. It is also recognized that there is a value in having a place to put signage in a prominent place on the instrument so the performer can promote his name, the name of the group of musicians or the name of the institution or venue.

The invention provides a percussion instrument that has many percussion sounds, many unique to this instrument. It is customizable with receptacles for permanently mounting peripheral instruments in a protected area. Peripheral instruments can also be temporarily mounted such as placing instruments in a receptacle or hanging instruments from the sides of the instrument. These individual instruments can be professionally manufactured instruments such as xylophones and wood blocks or can be house hold or industrial objects that are found to produce a pleasing unique percussion sound.

The invention can be placed on ones lap to play or can be used with a strap so the musician can move about while playing. It can also be used with a stand, enabling the musician to stand up while playing. The invention can be placed on the floor and played with the feet by a musician playing another instrument such as a guitar or ukulele, or in tandem with another percussion box being played on the lap. In either of these instances the musician will be able to maintain proper posture and play the instrument without overextending the arms or require improper wrist movement limiting fatigue or permanent or temporary injury.

In accordance with the several unique sounds the invention produces, there are several sizes of walls and wall sections that all produce different tones, including one wall that produces a deep bass tone. There are indentations on the surface of the instrument that are placed at different distances apart, that when ran over by a finger nail or a finger with a thimble on it, produce a unique sound. There are indentations of different shapes and sizes that produce unique sounds when struck. The invention can have an air port that will increase its volume, allow for certain tunings, and to accent certain frequencies. The port can also be actively manipulated by one hand while striking the instrument with the other had producing a unique sound. The corners and walls can have slightly different thicknesses which will produce different unique sounds when hit with the hand, finger, finger with thimble, or regular drumsticks, brushes, or mallets. There are limitless unique sounds that can be produced by attaching to or hanging objects from the instrument.

In accordance with another aspect of the present invention, the percussion box includes a recess formed in the front wall, where signage can be attached. Having the signage recessed protects the signage and allows the instrument to be placed on that side and not be wobbly.

In accordance with another aspect of the present invention, a removable panel or a door placed on one of the walls can give access to storage inside the instrument

In accordance with another aspect of the present invention, the percussion box will be light weight enough to be carried in one hand, and will have a handle for carrying.

In accordance with another aspect of the present invention, a rib may be integrally formed in the top wall to maintain the top wall in a flat configuration,

In accordance with another aspect of the present invention, the walls may be oriented such that a front of the percussion instrument is larger than the back of the percussion instrument to project the sound produced forward towards the audience.

In accordance with another aspect of the present invention, the bottom wall can be formed to be comfortable to set on ones legs, and include rails to assist in keeping the instrument from moving about while playing sitting down or on a stand

In accordance with another aspect of the present invention, indentations can be strategically placed to enable the instrument to be played by the feet directly or with a foot pedal.

Additional features and advantages of the invention will be set forth in the detailed description which follows, taken in conjunction with the accompanying drawing, which together illustrate by way of example, the features of the invention.

### DRAWINGS

### Brief Description of the Drawings

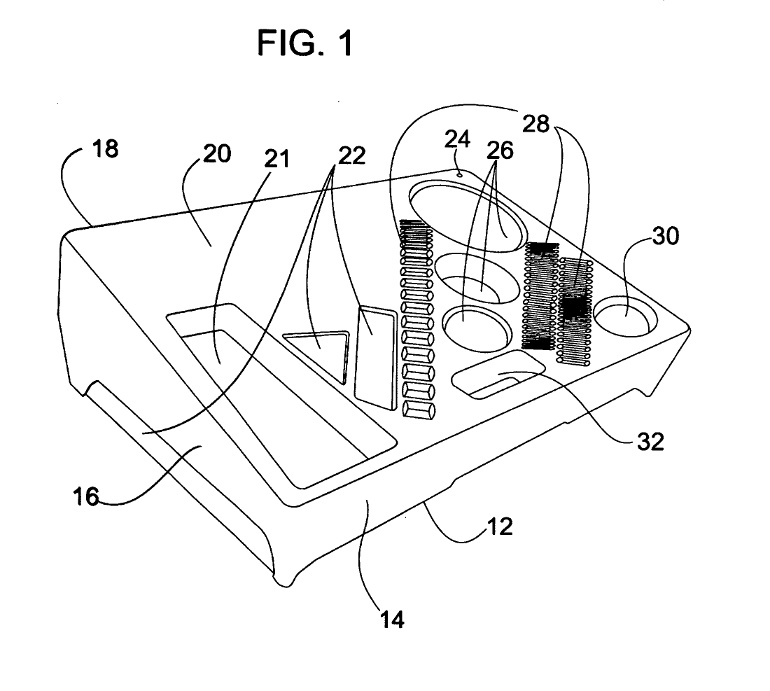

FIG. 1 is a perspective view of a percussion instrument in accordance with the present invention.

FIG. 1a is a perspective view of the percussion instrument shown in FIG. 1 with instruments attached to, and or set on the percussion instrument.

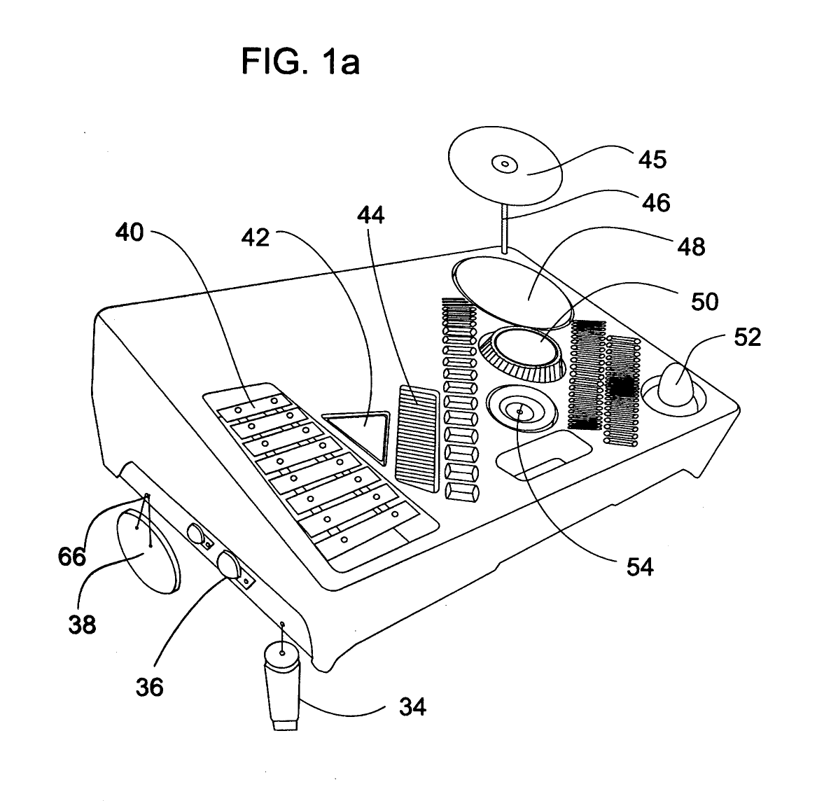

FIG. 2 is a front perspective view of the percussion instrument shown in FIG. 1.

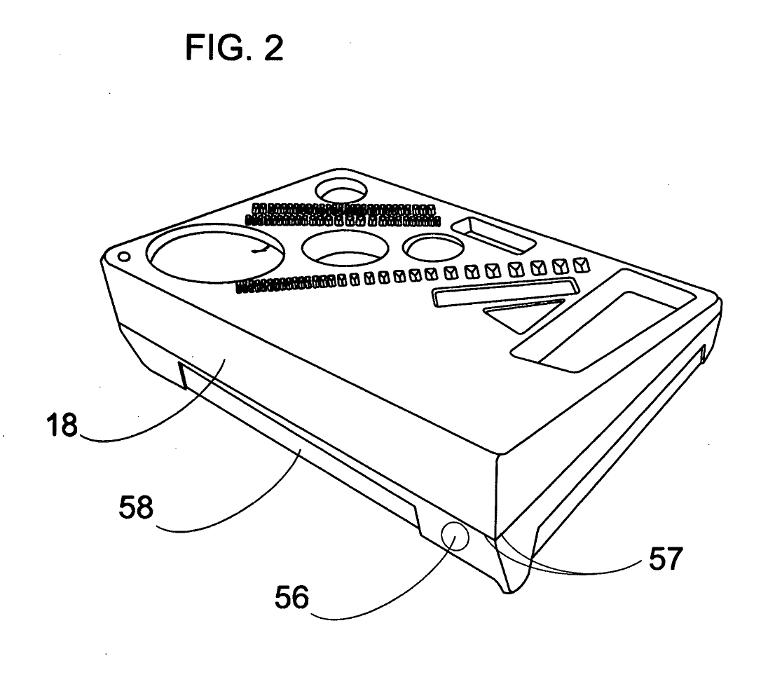

FIG. 3 is the bottom view of the percussion instrument of FIG. 1.

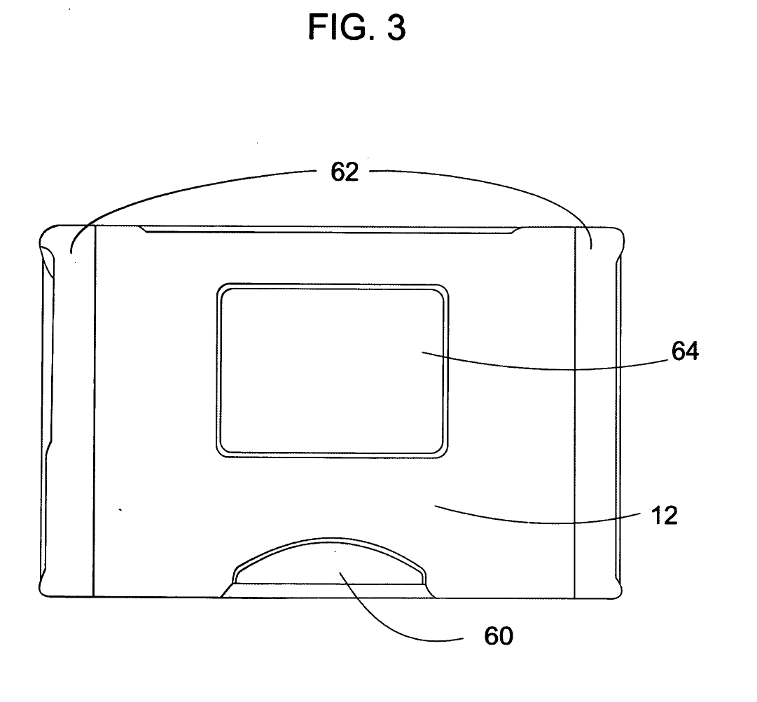

FIG. 4 is a side view of the percussion instrument of FIG. 1 also showing instruments attached; attachments for additional instruments, and attachments for strap.

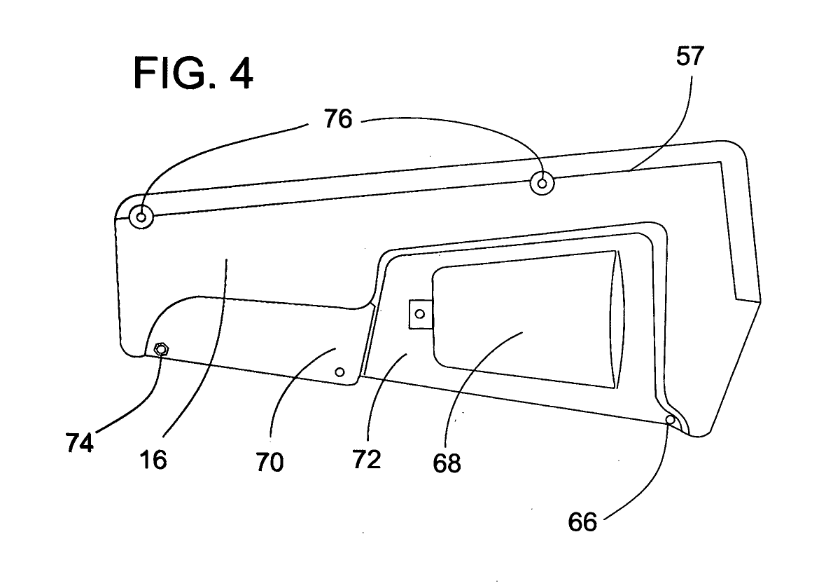

FIG. 5 is a view showing the percussion instrument of FIG. 1 in a sitting playing position.

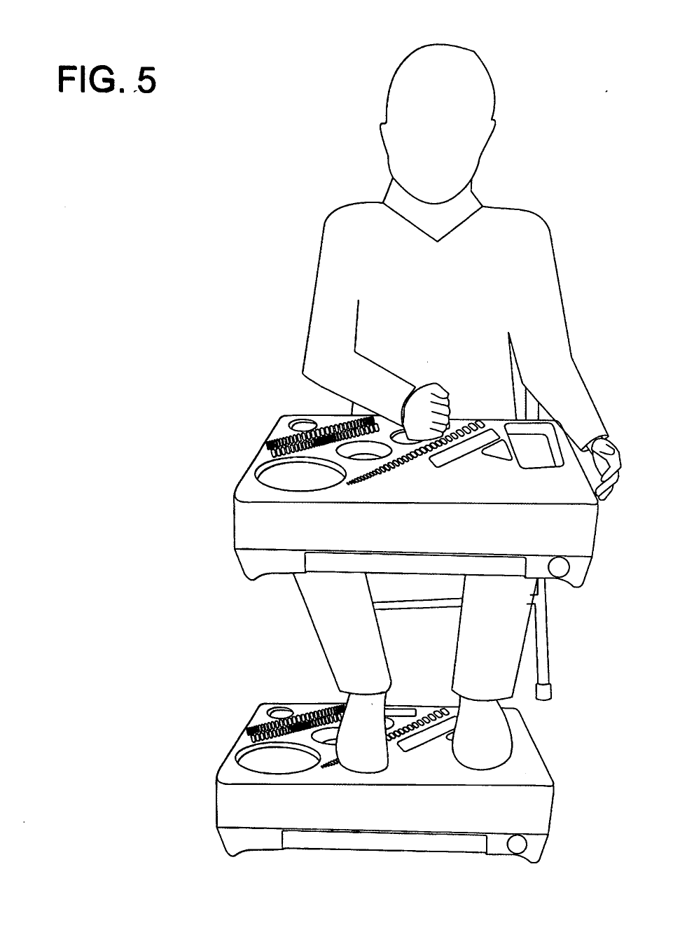

FIG. 6 is a view showing the percussion instrument of FIG. 1 in a standing playing position.

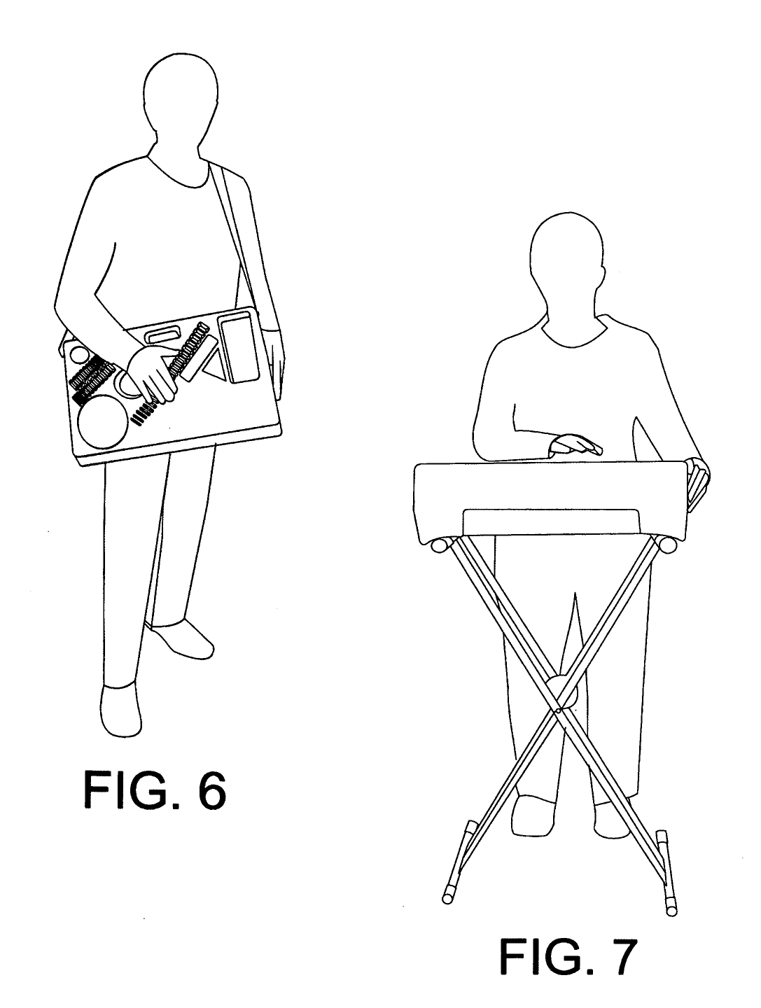

FIG. 7 is a view showing the percussion instrument of FIG. 1 in a standing playing position using a stand.

DRAWINGS-Reference Numerals

10 enclosure
12 bottom wall
14 rear wall
16 side wall
18 front wall
20 top wall
21 receiving area/also for foot
22 receiving areas
24 threaded insert
26 playing areas
28 patterned dips
30 playing area
32 handle
34 brass casing
36 domed spoons
38 gong
40 xylophone
42 textured metal
44 textured metal
46 stand with cymbal
48 pizza pan
50 dish
52 egg shaker
54 finger cymbal
56 air port
58 recess for signage
60 relief and handle
62 restraints
64 access panel/door
66 hanger
68 cowbell
70 receiving area
72 receiving area
74 audio connector
76 strap fasteners

### DETAILED DESCRIPTION

### FIGS. 1, 1A, 2, 3, AND 4—Preferred Embodiment

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to someone skilled in the relevant art and having possession of this disclosure, are to be considered within the scope of the invention.

As illustrated in FIGS. 1-5, a percussion instrument, indicated generally, in accordance with the present invention is shown. The term “percussion instrument” is used broadly herein to refer to any type of percussion instrument or drum, and the like.

The percussion instrument illustrated in FIG. 1 (back view) and FIG. 2 (front view) advantageously is formed of a single continuous shell, or unitary integrated shell. Thus, the shell is a single unitary structure which is continuously and integrally formed. The shell advantageously includes an integral exterior wall, or continuous wall. The integral and continuous wall includes a top wall 20, a front wall 18, side walls 16, a rear wall 14, and a bottom wall 12, which collectively enclose a hollow interior cavity.

The top wall 20 has a support surface configured to be played on. The top wall 20 may be oriented at an angle facing generally upward and toward the musician. The front wall 18 is configured to face towards an audience. In addition, the front wall 18 preferably has a height sufficient to be played on along with room for a tunable air port 56 and an area for signage 58. The opposite side walls 16 also have a height sized to enable playing on and or attaching peripheral instruments on. The rear wall 14 is configured to face the musician and also has a height sized to create an air space and or incorporate at handle 32 that is molded in or attached. Finally, the bottom wall 12 is configured to be set on the musicians lap, on the floor, or on a stand and incorporate a receptacle 64 for an access panel or door.

Thus, the continuous integral shell and the integral continuous wall are formed by the top wall 20, front wall 18, side walls 16, rear wall 14, and bottom wall 12, which are integrally formed together and extend continuously about the shell or perimeter of the percussion instrument. In addition, the walls form a single unitary structure or shell which is capable of supporting its own weight, in addition to any weight placed on the top wall 20. The continuous and integral nature of the walls and shell provide rigidity to the shell and prevent attachments or joints which may be weakened by transportation of the percussion instrument. The size and thickness contribute to the ability of the instrument to produce a large variety of sounds including low frequency sounds. The hollow interior cavity enclosed by the walls advantageously reduces the weight of the percussion instrument and contributes to the ability of the instrument to create a low frequency sound.

The shell and/or walls preferably are formed of a non-brittle plastic material like polyurethane. The plastic material has the acoustic properties to create a pleasing percussive sound while being durable enough to withstand being played on with hands, thimbles, drum sticks, brushes, drum mallets and the like. The plastic material is also lightweight and waterproof. In addition, the plastic material may be provided with a coloring. Thus, the coloring extending through the plastic material will help hide any scratches or dings in the walls. The single unitary shell, continuous integral walls, and plastic material of the percussion instrument advantageously allow the shell and walls to be produced by rotational molding or blow molding.

The top wall 20 includes a perimeter which includes an edge joining the top wall to the front wall 18, side walls 16, and rear wall 14. All corners and edges are preferably rounded.

As indicated above, the shell is a lightweight structure. Thus, one or more of the walls may be formed with a curvature to add strength to the walls and prevent buckling or warping. The front wall 18 can be curved. Alternatively, it can be curved from bottom to top and or from side to side. In addition, the side walls 16 or rear wall 14 may also be formed with a similar curvature. In addition, the corners and especially the outside edges are curved or rounded to increase rigidity and prevent warping along with making the percussion box more ergonomic or comfortable to play and avoid injury.

As stated above, the front wall 18 is configured to face the audience. Therefore, the front wall 18 preferably has an aesthetically pleasing surface. Referring to FIG. 3, a recess 58 preferably is formed in the front wall 18. A decorative insert or signage advantageously is disposed in the recess 58. The decorative insert or signage may have a forward facing surface, such as wood, etc., which is aesthetically pleasing and which may be chosen to match a logo or trademark. The recess 58 advantageously covers the edges of the insert or signage, such that the insert may be a laminate or the like. In addition, the recess 58 advantageously helps prevent damage to the insert or signage. The insert or signage may be attached to the front wall 18 or within the recess 58 in any appropriate manner, such as with screws, adhesive, hook and loop type fasteners and the like, etc. In addition, the insert may be releasable secured within the recess 58, such that various different inserts may be used. For example, different inserts with different logos thereon may be interchanged to suit the particular situation. In addition, insert may be acoustically transparent allowing it to cover one or more of the air ports placed in this area.

As stated above, the front of the percussion instrument or front wall 18, preferably is configured to be aesthetically pleasing as it faces the audience. Thus, the front wall 18 or front of the percussion instrument may be configured to be larger than the back of the percussion instrument to help project the sound forward toward an audience.

The side walls 16, rear wall 14, and front wall 18 may taper from a wider point towards the top wall 20 and the bottom wall 12. Thus, a parting line 20 may be located along the side walls 16, the rear wall 14, and the front wall 18 to facilitate molding the percussion box.

The wall forming the shell has a thickness. Preferably, the thickness of the walls of the shell is approximately ⅙-in.-⅜-in., and most preferably approximately ⅛-in. The thickness of the walls of the shell preferably is substantially consistent throughout the shell accept near the corners which will provide better structure and provide a larger degree of variance to the sounds produced when struck.

The interior of the box may be substantive enough so that when the instrument is hit with the hand, mallet or the like, it will produce a low bass sound. Additionally at least one of the walls of the instrument may be large enough and flexible enough so that when hit with the, hand, mallet or the like, it will produce a low bass sound.

The walls may be sectioned of into different sizes that will produce different tones. In addition there may be different tones within different areas of each wall section. Specific indentations 21,22,26,30,32, produce different types of sounds. Specifically indentation 21 provides a higher pitched tone for playing the invention with the feet.

Ribs 28 may be integrally formed in the top wall 20, or other walls sized and or spaced the same or varied in size and spacing that allow the musician to create unique sounds. In addition, the ribs 28 may form an indentation or extend up from the surface of the instrument.

The percussion instrument may have indentations 21, 22, 26, 30, 70, and 72 or protrusions for receiving various music instruments. These instruments may be standard percussion or music instruments; such as a xylophone 40, gong, 38 finger cymbal 54, cow bell 68 or they may be any item that will produce a sound that the musician would like to incorporate into the instrument such as a bullet casing 34, domed spoons 36, cupcake holder 50 or a kitchen pan 48. These instruments can also be made specifically for the percussion box such as a textured stainless steel plate 42 or corrugated aluminum 44. These peripheral instruments can be permanently attached as with the cow bell 68 or domed spoons 36 to the percussion box or they can be set in place as in the egg shaker 52 to be played in place or to be picked up and played. Indentations such as 21 can also be used as a placement for a foot when the invention is placed on the floor and played with the feet.

In addition there may be indentations around the circumference of the percussion box allowing fasteners 66 to mount or hang standard instruments or items that the musician chooses. These additional instruments or items can also be attached permanently or temporarily attached via hardware such as hooks and can be traditional instruments, household items or custom made instruments.

One or more molded in fasteners 24 may be placed on the top wall 20 or other walls to facilitate mounting instruments or stands for instruments 46 such as cymbals 45. Other stands or mount can be bolted, riveted or screwed onto the shell of the percussion box. Such stands can also be used for microphones.

The percussion instrument may also include an area for receiving an electronic pickup or microphone to amplify and vary the sound the percussion box produces. Thus, the percussion instrument may include a connector 74 for a cable to be used to connect the pickup or microphone to a mixer.

A handle 32 may be formed in the percussion box to facilitate carrying the instrument easily. The bottom wall 12 may have an indentation 60 near the center back portion of the wall to provide comfort while the instrument is sitting on the musicians' lap that may incorporate part of the handle section.

A recessed area 64 on the bottom wall 12 may be incorporated in the percussion box to facilitate attaching an access panel or door or access to in cavity of the percussion box for storage of peripheral instruments or other items. The recessed area 64 will be indented sufficiently to keep the panel or door hardware from protruding outward beyond the bottom wall protecting it from ware and providing more comfort to the musician while playing the instrument on the lap.

The percussion instrument may have hardware 76 for a strap to be attached so that the musician can be mobile while playing the instrument. The strap can also help keep the instrument from moving while sitting down.

Lights may be incorporated into the percussion instruments and set to match the beat of the playing. Lights can be used to light the signage and can even be used to change the color of the percussion instrument by using a semi translucent plastic and placing the lights on the inside of the box.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

### Operation—FIGS. 5, 6, and 7

Referring to FIG. 5 the bottom wall 12 of the percussion instrument is configured to be set upon the musicians lap. In addition the side walls 62 may extend downward beyond the bottom wall 12 and rounded up to the bottom wall 12 to help keep the instrument from shifting side to side. This section of the side walls can also be tapered to help keep the instrument from sliding forward.

Referring to FIG. 6 hardware for attaching a strap may be fastened to the percussion box to allow the musician to be mobile while playing. Straps or clamps may be incorporated to hold the instrument in place. The same strap may be used to keep the instrument from shifting forward while playing the instrument on ones lap.

Referring to FIG. 7 the bottom wall 2 of the percussion instrument is configured to be set upon a keyboard stand. In addition the side walls 4 may extend downward beyond the bottom wall 2 and rounded up to the bottom wall to help keep the instrument from shifting side to side. Straps or clamps may be incorporated to hold the instrument in place.

What is claimed is:

1. A music percussion instrument, comprising: a hollow shell with a plurality of rises and or cavities of different sizes and shapes that create different sounds when struck.

2. A percussion instrument in accordance with claim 1, wherein the exterior walls are made of a material that will withstand being played on with thimbles without being damaged.

3. A percussion instrument in accordance with claim 1, further comprising: a recess, formed in the front wall; for receiving signage.

4. A percussion instrument in accordance with claim 1, further comprising an air port, to allow air to enter and escape the interior cavity.

5. A Musical instrument in accordance with claim 1, further comprising: a built in handle for carrying the instrument.

6. A percussion instrument in accordance with claim 1, wherein patterns of dips and or rises on the surface will produce musical sounds when running the fingernail or other object across them.

7. A percussion instrument in accordance with claim 1, further comprising: a recess, formed in a wall, for receiving an access door for storing other instruments inside the cavity of the instrument.

8. A percussion instrument in accordance with claim 1, further comprising: indentations for forming around a players legs to help hold the instrument in place.

9. A percussion instrument in accordance with claim 1, further comprising hardware that is attached to facilitate holding the instrument while standing and moving around.

10. A percussion instrument in accordance with claim 1, wherein fasteners can be molded in or added, to allow attachment of stands for cymbals or other instruments.

11. A percussion instrument in accordance with claim 1, further comprising an area at the bottom of the instrument to allow attaching to a stand.

12. A percussion instrument in accordance with claim 1, further comprising receptacles for playing the instrument with the feet.

13. A percussion instrument in accordance with claim 1, further comprising a snare comprising of springs or wires that are fixed against a wall.

14. A percussion instrument in accordance with claim 1, wherein at least one wall is large enough and flexible enough to produce a low tone when struck.

15. A percussion instrument in accordance with claim 1, further comprising microphones and or pickups fastened to the shell.

16. A percussion instrument in accordance with claim 1, further comprising LED lights fastened to the shell.

17. A music percussion instrument, comprising: a hollow molded shell with a plurality of playing surfaces including at least one surface with dips and or rises of similar or different sizes set at regular and or different intervals that create different sounds when running a fingernail or other instrument across them.

18. A music percussion instrument, comprising: a hollow shell with a plurality of walls with playing surfaces that have a means of receiving and or attaching peripheral instruments.

19. A percussion instrument in accordance with claim 18, further comprising a plurality of rises and or cavities of different sizes and shapes that create different sounds when struck.

20. A percussion instrument in accordance with claim 18, further comprising: a recess, formed in a wall, for receiving an access door for storing other instruments inside the cavity of the instrument.
